(19) United States
(12) Patent Application Publication
(10) Pub. No.: US 2008/0210570 A1
(43) Pub. Date: Sep. 4, 2008

(54) Anodic Electrodeposition Paint, Production And Use Thereof, Use Of Lamellar Metal Pigment, And Coated Object

(76) Inventors: Thomas Schuster, Lauf (DE); Harald Weiss, Furth (DE); Christian Schramm, Hersbruck (DE); Robert Maul, Winkelhaid (DE); Carolin Schmidt, Velden (DE)

Correspondence Address: OSTROLENK FABER GERB & SOFFEN, 1180 AVENUE OF THE AMERICAS, NEW YORK, NY, 100368403, US

(21) Appl. No.: 11/913,001

(22) PCT Filed: May 2, 2006
(86) PCT No.: PCT/EP2006/004089

§ 371 Date: Feb. 13, 2008

(30) Foreign Application Priority Data
May 2, 2005 (DE) 10 2005 020 767.7

(51) Int. Cl. C09D 5/44

(52) U.S. Cl. 205/316

(57) ABSTRACT

The invention relates to an anodic electrophoretic paint comprising at least one binding agent for anodic electrophoretic paint and an aqueous liquid medium, which anodic electrophoretic paint additionally contains at least one platelet-type metal pigment coated with a coating composition, wherein
(a) the platelet-type metal pigment has a d₅₀ value of the cumulative size distribution curve of from 4 to 35 μm and is selected from the group consisting of leafing metal pigments, metal pigments coated with synthetic resin(s), and mixtures thereof, and
(b) the coating composition is a coating composition having an organic backbone containing at least 10 carbons and possessing one or more functional groups for effecting adhesion or binding to the pigment surface, wherein the functional group is selected from the group consisting of phosphonic acids, phosphonates, phosphoric acids, phosphate esters, sulfonates, polyalcohols, and mixtures thereof, and
(c) the coating composition exhibits acidic properties.

The invention relates to a process for the production of the electrophoretic paint and to uses thereof.

The invention relates to an anodic electrophoretic paint containing metal effect pigments. The invention further relates to a method for the production of an anodic electrophoretic paint and to the use of platelet-like metal effect pigments in an electrophoretic paint or for electrophoretic painting. The invention also relates to the use of the electrophoretic paint and to a coated article.

Electrophoretic painting (EPP) is a method for applying specific water-soluble paints, so-called electrophoretic paints, on electrically conductive substrates, for example, a workpiece. A DC voltage field is applied between a workpiece immersed in a paint bath and a counter-electrode. A distinction is made between anodic deposition, so-called anodic electrophoretic painting (AEP), in which the workpiece is wired as the anode or the positive pole, and cathodic deposition, so-called cathodic electrophoretic painting (CEP), in which the workpiece is wired as the cathode or the negative pole.

The paint binder contains functional groups of a specific polarity, which are present in a salt form due to neutralization and are thus colloidally dissolved in water. Near the electrode (within the diffusion boundary layer), hydrolysis produces hydroxide ions in CEP and H⁺-ions in AEP. These ions react with the binder salt; and the functionalized binders lose their salt form (“salt out”), with the result that they become water-insoluble and coagulate on the surface of the workpiece. As the process proceeds, the coagulated binder particles lose water due to electroosmosis operations, and the binder particles are compacted further. Finally, the workpiece is removed from the electrophoretic bath, freed from uncoagulated paint particles in a multi-stage rinsing process and baked at temperatures of from 150 to 190° C. (Brock, Groteklaes, Mischke, “Lehrbuch der Lacktechnologie”, 2^{nd} Edition, Vincentz Verlag 1998, pp. 288 et seq.). Electrophoretic painting has several economical and ecological advantages over conventional painting procedures such as painting with wet paint or powder paint.

The primary advantage deserving mention here is the precise adjustment of the layer thickness. Contrary to powder painting, even those points of the workpiece that are difficult to access are coated uniformly during electrophoretic painting. This is due to the following fact: first the binder is deposited on points having a high field strength, such as corners and edges. However, the film undergoing formation has high electrical resistance. Therefore, the flux lines shift to other regions of the workpiece and become fully concentrated at the most inaccessible regions of the workpiece on conclusion of the coating procedure, for example, those regions or points lying inside the workpiece (interior coating). Thus, workpieces having arbitrary shapes can be coated by electrophoretic painting (EPP) as long as they are electrically conductive. Furthermore, EPP is associated, to advantage, with properties such as minimum solvent emissions, optimum material yield, and non-combustibility. Coatings free from tears and sags are achieved. Electrophoretic painting is performed automatically and is thus a very economical painting procedure, particularly since it can be performed using low current densities of only a few mA/cm².

Due to the simple and extremely economical method of application, electrophoretic painting is currently used in numerous systems. The most prevalent uses to be mentioned are primers, e.g. for painting automobiles in mass production, and single-layer top coatings. Electrophoretic painting is used, for example, on radiators, control cabinets, office furniture, in building, on ironmongery and domestic appliances, in warehouse engineering and shelf construction, in air-conditioning and lighting technology, and in the production of equipment and machinery.

Anodic electrophoretic painting (AEP) is used for special applications and materials. It is primarily suitable for top paint coating of nonferrous metals providing highly transparent protective layers and for depositing colored paints. Baking results in very homogeneous, smooth, and corrosion-resistant surfaces. These surfaces have almost no variation in layer thickness (edge build-up). For this reason, articles of complex geometrical shapes also can be completely coated using this procedure. Likewise, paints applied by anodic electrophoretic painting achieve very good scores in terms of resistance to temperature and to aging. Environmental acceptability due to the substantial absence of organic solvents rounds off the advantages of anodic electrophoretic painting, making it a most efficient and attractive coating method.

The electrophoretic paints used hitherto are water-based paints, which usually contain epoxy resins, and rarely also polyacrylates, as binders. Electrophoretic paints may contain conventional colored pigments, which usually include organic and inorganic colored pigments. However, the range of colors used commercially is very limited. Effect pigments have not hitherto been used in electrophoretic paints on a commercial basis.

DE 199 60 693 A1 discloses a method for anodic electrophoretic painting, which contains from 1 to 15% by weight of one or more phosphoric acid epoxy esters and/or phosphonic acid epoxy ester/s, based on the binding solids in the electrophoretic paint. DE 199 60 693 A1 states that pigments, such as, for example, metal pigments might also be added to the electrophoretic paint. However, it has been found that the mere addition of metal pigments in the anodic electrophoretic painting method disclosed in DE 199 60 693 A1 is not sufficient for depositing metal pigments onto a workpiece.

EP 0 477 433 A1 discloses metal pigments coated with synthetic resins, a very thin siloxane layer being applied as an adhesion promoter between the surface of the metal pigment and the synthetic resin layer. However, these pigments cannot be used as such for electrophoretic painting. Furthermore, this document makes no mention of electrophoretic painting.

DE 690 02 991 T2 discloses a water-based coating composition that contains metal pigments and is also reported to be suitable for electropolishing. The metal pigments can also be flake-like, i.e. substantially of platelet configuration. However, this document does not provide any further information on the metal pigments, which cannot, in fact, be used in electrophoretic painting within the scope claimed therein.

It is an object of the present invention to provide an anodic electrophoretic paint, which contains metal pigments and by means of which metallic electrophoretic paint coatings can be obtained. The metal pigments must be corrosion-resistant to the aqueous electrophoretic paint vehicle and must be capable of deposition. The anodic electrophoretic paint should have a bath stability of at least 60 days. Electrophoretic paint coatings produced using the anodic electrophoretic paint should have a metallic effect, the optical quality of which should preferably match that of powder paints.

Furthermore, it is an object of the present invention to provide a method for the production of an electrophoretic paint containing metal pigments.

This object is achieved by providing an anodic electrophoretic paint comprising at least one binder for anodic electrophoretic paint and an aqueous liquid medium, the anodic electrophoretic paint additionally containing at least one platelet-like metal pigment that is coated with a coating composition, wherein

(a) the platelet-like metal pigment has a d₅₀ value of the cumulative size distribution curve of from 4 to 35 μm and is selected from the group consisting of leafing metal pigments, synthetic resin-coated metal pigments, and mixtures thereof and

(b) the coating composition a coating composition comprising an organic backbone containing at least 10 carbons, said coating composition being provided with one or more functional groups for effecting adhesion or binding to the pigment surface, the functional group being selected from the group consisting of phosphonic acids, phosphonic acid esters, phosphoric acids, phosphoric acid esters, sulfonates, polyols, and mixtures thereof, and

(c) the coating composition has acidic properties.

Preferred developments of the invention are defined in the Subclaims 2 to 15.

Furthermore, the object is achieved by providing a method for the production of an electrophoretic paint according to any one of claims 1 to 15, the method comprising the following steps:

(a) coating the metal pigment with the coating composition,

(b) mixing the coated metal pigment obtained in step (a) with at least one binder of the electrophoretic paint and solvent, it being possible to mix the binder and the metal pigment in several sub-steps,

(c) optionally adding aqueous liquid medium for adjusting the viscosity,

(d) optionally neutralizing the electrophoretic paint.

The object of the invention is also achieved by the use of an anodic electrophoretic paint according to any one of claims 1 to 15 for coating an electrically conductive substrate or article.

The object of the invention is likewise achieved by providing an article coated with an anodic electrophoretic paint according to any one of claims 1 to 15. The article is preferably selected from the group consisting of radiators, fuel tank installations, automobile bodies, automobile accessories, domestic and electrical appliances, furniture, steel furniture, components, and building and agricultural equipment.

Finally, the object of the invention is achieved by the use of platelet-like leafing metal pigments, which are coated with a phosphoric acid ester of formula (I) or a phosphonic acid ester of formula (II):

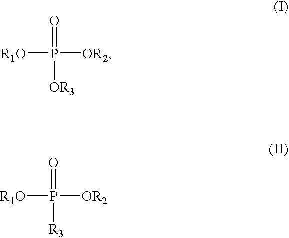

in which R₁, R₂, and R₃ can independently stand for
alkyl containing from 10 to 20 carbons, straight-chain or branched, optionally substituted by fluorine and/or hydroxyl,
aryl containing from 6 to 24 carbons, optionally substituted by alkyl containing from 1 to 6 carbons, or by fluorine and/or hydroxyl, the total number of carbons being equal to at least 10,
in which R₁ and R₂ can also independently stand for hydrogen, for the production of an anodic electrophoretic paint or for use in anodic electrophoretic painting.

Preferred developments of the use of the electrophoretic paint of the invention are defined in subclaims 20 and 21.

The object of the invention is also achieved by the use of platelet-like leafing metal pigments and/or metal pigments coated with synthetic resin(s), the pigments being coated with a coating composition which comprises an organic backbone containing from 10 to 800 carbons and preferably from 12 to 100 carbons, and is selected from the group consisting of alkyl, alkenyl, alkynyl, aryl, alkylaryl, arylalkyl, alkenylaryl, arylalkynyl, alkynylaryl, cycloalkyl, alkylcycloalkyl, cycloalkylalkyl, perfluorinated alkyl, partially fluorinated alkyl, perfluorinated aryl, partially fluorinated aryl, perfluorinated alkylaryl, and partially fluorinated alkylaryl, and combinations and mixtures thereof, for the production of an anodic electrophoretic paint or for use in anodic electrophoretic painting.

The metal pigments may be of metals or alloys selected from the group consisting of aluminum, copper, zinc, brass, iron, titanium, chromium, nickel, steel, silver, and alloys thereof. Of course, mixtures of the aforementioned metal pigments may be used, if desired, aluminum pigments and brass pigments being preferred for the purposes of the invention, while aluminum pigments are particularly preferred.

The metal pigments are always of a platelet-like nature. These are to be understood as pigments in which their average longitudinal extent (d₅₀ value of the cumulative size distribution curve) is at least ten times, preferably at least twenty times and more preferably at least fifty times their average thickness. For the purposes of the invention, the term “metal pigments” always refers to platelet-like metal pigments.

The metal pigments used in the electrophoretic paint have average longitudinal extents, which are determined by means of laser granulometry (Cilas 1064, supplied by Cilas) as ball equivalents and represented as the d₅₀ value of the corresponding cumulative size distribution curve. These d₅₀ values range from 4 to 35 μm and preferably from 5 to 25 μm. It has been found, surprisingly, that it is virtually impossible to deposit very large pigment particles having a d₅₀ value above 100 μm. Apparently, the migration and deposition properties are considerably reduced in the case of larger particles. Of such coarse pigment distributions, only fractions of less than approx. 100 μm (fine-grained portion) are deposited. However, this considerably reduces the size and size distribution of the deposited particles compared with the particles originally used. Smaller particles are preferred for this reason. At a d₅₀ value ranging from approx. 4 μm to 35 μm, the pigments of the invention are readily deposited over their entire size distribution. Furthermore, at sizes ranging from 4 μm to 35 μm, pigments enable bath times or a bath stability of more than 60 days to be achieved.

Particles having a d₅₀ of less than 4 μm are too fine to produce an attractive visual effect. Another effect is that gassing problems may occasionally occur in the aqueous electrophoretic paint medium in such cases due to the very high specific surface area of the fine pigments.

The average thickness of the metal pigments of the invention, on the other hand, is from 50 to 5,000 nm, preferably from 100 to 800 nm and more preferably from 250 to 500 nm.

Electrophoretic paints are always water-based systems. For this reason, metal pigments present in electrophoretic paint must be provided with a protective layer, in order to combat the corrosive effect of water on the metal pigment. Furthermore, they must have suitable surface charges, in order to possess sufficient electrophoretic mobility in the electric field.

These requirements are met, surprisingly, when the platelet-like metal pigment is selected from the group consisting of leafing metal pigments, metal pigments coated with synthetic resins, and mixtures thereof.

The coating composition is an organic coating composition having an organic backbone containing at least 10 carbons, which coating composition has one or more functional groups for effecting adhesion or binding to the pigment surface, the functional group being selected from the group consisting of phosphonic acids, phosphonic acid esters, phosphoric acids, phosphoric acid esters, sulfonates, polyols, and mixtures thereof, and the coating composition has acidic properties.

For the purposes of the invention, the term “binder functionalities” means functional groups such as characterize binders of an anodic electrophoretic paint.

For the purposes of the invention, the term “adhesion” means non-covalent interactions, such as hydrophobic interactions, hydrogen bonding, ionic interactions, van der Waals forces, etc., that lead to immobilization of the coating composition on the surface of the pigment.

The term “binding” means, for the purposes of the invention, covalent bonds which lead to covalent immobilization of the coating composition on the surface of the pigment.

The term “acidic properties” means, for the purposes of the invention, that the coating composition comprises acidic groups, acid groups, negatively ionizable groups, or groups having negative charges.

According to a preferred development of the invention, the metal pigments are leafing metal pigments and/or metal pigments which are coated with a synthetic resin layer and which have been treated with at least one coating composition containing suitable binder functionalities for electrophoretic paints.

The leafing metal pigments are metal pigments which accumulate on the surface, or close to the surface, of the binder due to incompatibility of their surface-chemical properties with the surrounding binder. All leafing metal pigments known in the prior art can be used. Preferably they are metal pigments ground and/or after-polished with saturated, fatty acids containing from 10 to 30 carbons. The fatty acids can be linear or branched. The leafing pigments are preferably ground and/or after-polished with stearic acid and/or palmitic acid. The stearic acid and palmitic acid used are of technical quality—i.e. they contain small quantities of higher and/or lower fatty acid homologs. Furthermore, leafing metal pigments may be metal pigments that have been treated with additives containing alkyl chains.

Examples thereof are decylphosphonic acid or alkyl alcohol phosphoric acid esters such as the product FB 7234/S supplied by Zschimmer & Schwarz GmbH & Co (Max-Schwarz-Str. 3-5, D-56112 Lahnstein/Rhine).

Surprisingly, the use of the electrophoretic paint of the invention containing metal pigments based on a leafing metal pigment, likewise produces, after electrophoretic painting, an extremely brilliant metallic coat of paint that likewise has a leafing effect.

However, a particularly surprising fact is that these leafing metal pigments are permanently incorporated in the paint layer and display no abrasion. This has hitherto been impossible with leafing metal pigments used in, say, powder paint.

The metal pigments coated with synthetic resins contain a coating of polymers. These polymers are polymerized onto the metal pigments starting from monomers. The synthetic resins comprise acrylates, methacrylates, esters and/or urethanes. In a preferred embodiment, the coated metal pigment is coated with at least one methacrylate and/or acrylate. Particular preference is given to those metal pigments that have been produced according to the teaching of EP 0 477 433 A1, incorporated herein by reference. Such pigments contain, between the metal pigment and the synthetic resin coating, an organofunctional silane, which serves as adhesion promoter. Coatings containing preferably poly-cross-linked acrylates and/or methacrylates are preferred. Such coatings already provide good protection from the aqueous medium of electrophoretic paints. Similar pigments are described in DE 36 30 356 C2, the difference being that an ethylenically unsaturated mono- or di-carboxylate and/or mono- or di-phosphorate serve as the adhesion promoter.

Examples of such cross-linkers are: tetraethylene glycol diacrylate (TEGDA), triethylene glycol diacrylate (TIEGDA), polyethylene glycol 400 diacrylate (PEG400DA), 2,2′-bis(4-acryloxyethoxyphenyl)propane, ethylene glycol dimethacrylate (EGDMA), diethylene glycol dimethacrylate (DEGDMA), triethylene glycol dimethacrylate (TRGDMA), tetraethylene glycol dimethacrylate (TEGDMA), butyl diglycol methacrylate (BDGMA), trimethylol propane trimethacrylate (TMPTMA), 1,3-butanediol dimethacrylate (1,3-BDDMA), 1,4-butanediol dimethacrylate (1,4-BDDMA), 1,6-hexanediol dimethacrylate (1,6-HDMA), 1,6-hexanediol diacrylate (1,6-HDDA), 1,12-dodecandiol dimethacrylate (1,12-DDDMA), and neopentyl glycol dimethacrylate (NPGDMA). Trimethylol propane trimethacrylate (TMPTMA) is particularly preferred. These compounds are commercially available from Elf Atochem Deutschland GmbH, D-40474 Duesseldorf Germany or Rohm & Haas, In der Kron 4, 60489 Frankfort-on-Main, Germany.

The thickness of the synthetic resin coating is preferably from 2 to 50 nm, more preferably from 4 to 30 nm and most preferably from 5 to 20 nm. The content of synthetic resin, based on the weight of the uncoated metal pigment, individually depends on the size of the metal pigments and is preferably from 1 to 25% by weight, more preferably from 2 to 15% by weight and most preferably from 2.5 to 10% by weight.

The coating composition is applied to the metal pigments after the formation of the synthetic resin layer. The synthetic resin layer can surround the pigments completely. However, it may surround the pigments incompletely or have cracks. The use of a coating composition having an organic backbone containing at least 10 carbons and having one or more functional groups for promoting adhesion or binding to the pigment surface, the functional group being selected from the group consisting of phosphonic acids, phosphonic acid esters, phosphoric acids, phosphoric acid esters, sulfonates, polyols, and mixtures thereof, makes it possible to prevent the occurrence of possible corrosion sites, which can be caused by such cracks or by an incomplete coating on the metal pigment. Particularly if the coating composition binds to the metallic pigment surface, it can penetrate into such gaps or cracks in the synthetic resin coating and thus provide the requisite corrosion resistance. Metal pigments, which are coated only with synthetic resin and are not treated with coating compositions, are not effective in anodic electrophoretic painting.

In electrophoretic painting, conventional colored pigments added to an electrophoretic paint are deposited on the workpiece by a more or less random process. The electrophoretic paint is constantly vigorously stirred during deposition. The transport of material to the workpiece takes place substantially by this means (convection). An electrophoretic migration of the charged binder particles in the electric field takes place only within the Nernst diffusion layer as it forms. The concentration of the colored pigments in the deposition bath is very high (approx. 10% by weight). The colored pigments are entrained by the depositing binder. No electrophoretic migration of the colored pigments takes place in the electric field.

Metal pigments per se cannot be used in electrophoretic paints. Even if they are made corrosion-resistant to the aqueous medium of the electrophoretic paint by a suitable protective layer, for example, a metallic oxide or a synthetic resin, either they are not deposited at all or they are no longer deposited after an initial deposition phase lasting a few hours or days (insufficient bath stability).

It has now been found, surprisingly, that the electrophoretic paint of the invention, which contains metal pigments coated with the coating composition described above, displays a bath stability of more than 60 days. Therefore, the metal pigments contained in the anodic electrophoretic paint of the invention are sometimes deposited reliably on the workpiece even after 60 days and preferably after 90 days.

The metal pigments must be coated with the coating composition described above before being incorporated in the electrophoretic paint.

The coating composition comprises an organic backbone containing at least 10 carbons and one or more functional groups for promoting adhesion and/or binding to the pigment surface, the functional groups being selected from the group consisting of phosphonic acids, phosphonic acid esters, phosphoric acids, phosphoric acid esters, sulfonates, polyols, and mixtures thereof, while the coating composition further has acidic properties.

For the purposes of the invention, the term “organic backbone” means a monomer or polymer linked to the functional group. For example, in decylphosphonic acid, the organic backbone is the “decyl” group.

The coating composition on the metal pigments preferably has an acid number of from 15 to 300 mg KOH/g of coating composition. The acidic groups required for this may be derived from the functional groups, which (can) cause adhesion or binding to the pigment surface.

The coating composition preferably has an acid number of from 17 to 150 mg KOH/g of coating composition and more preferably from 20 to 100 mg KOH/g of coating composition.

Coating compositions having an acid number of less than 15 mg KOH/g of coating composition have not proven to be suitable.

The acid number of the coating composition can be determined as specified in the standard DIN EN ISO 3682.

These acidic groups impart presumably sufficient negative surface charges to the electrophoretic paint pigment in order, firstly, to get well dispersed in the predominantly aqueous medium of the electrophoretic paint and, secondly, to be able to migrate electrophoretically in the electric field under the conditions of an anodic electrophoretic paint for the purpose of finally being able to participate in the deposition mechanism within the Nernst diffusion layer at the anode by means of the mechanism described above.

The coating composition can display functionalities corresponding to those of the binder or binders used for the respective electrophoretic paint. The binding functionalities of the binder and the binding functionalities of the coating composition may differ from each other.

Furthermore, it is preferred that also the functional groups adhering or binding to the pigment surface be acidic or charged negatively. The surface of the metal pigments is thus chemically adapted to the binders of the electrophoretic paint of the invention, thereby making it possible for the metal pigments to undergo electrophoretic migration in the electric field and thus to participate in the deposition mechanism of the electrophoretic paints.

The coating composition used for coating the metal effect pigments in the electrophoretic paint is preferably capable of being deposited anodically.

The coating composition has functional groups which adhere to, and/or bind to, the pigment surface, i.e. the metal pigment surface or the metal surface coated with synthetic resin. This makes it possible for the coating composition/s to be anchored to the metal pigments reliably and adequately.

Such functional groups are phosphonic acids, phosphonic acid esters, phosphoric acids, phosphoric acid esters, sulfonates, and/or polyols. The phosphonic acid esters or phosphoric acid esters may also be partially esterified systems.

According to a preferred embodiment, the coating composition is a phosphoric acid ester of formula (I) or a phosphonic acid ester of formula (II):

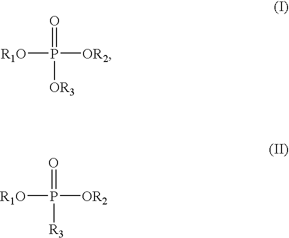

in which R₁, R₂, and R₃ can independently stand for
alkyl containing from 10 to 20 carbons, straight-chain or branched-chain, optionally substituted by fluorine and/or hydroxyl,
aryl containing from 6 to 24 carbons, optionally substituted by alkyl containing from 1 to 6 carbons, or by fluorine and/or hydroxyl, the total number of carbons being equal to at least 10,
in which R₁ and R₂ can also independently stand for hydrogen.

Polyols may alternatively be used as coating compositions. The term “polyols” means, for the purposes of the invention, a compound containing at least 4 OH— groups. The hydroxyl number of the polyols is equal to from 10 to 160 mg KOH/g of coating composition. These functional groups improve the water solubility of the metal pigment coated with the coating composition.

The organic backbone of the coating composition preferably has from 10 to 800, more preferably from 12 to 100 and very preferably from 20 to 30 carbons. According to a preferred development of the invention, the organic backbone is an oligomer or a polymer.

In a preferred embodiment of the invention, the organic backbone of the coating composition is selected from the group consisting of alkyl, alkenyl, alkynyl, aryl, alkylaryl, arylalkyl, alkenylaryl, arylalkynyl, alkynylaryl, cycloalkyl, alkylcycloalkyl, cycloalkylalkyl, perfluorinated alkyl, partially fluorinated alkyl, perfluorinated aryl, partially fluorinated aryl, perfluorinated alkylaryl, and partially fluorinated alkylaryl, and combinations and mixtures thereof.

Particular preference is given to a coating composition which is a phosphonic acid ester and/or phosphoric acid ester containing one or two esterified groups.

The coating composition is preferably a mixture of monoalkyl phosphoric acid esters and dialkyl phosphoric acid esters. Preferably, the alkyl groups are branched alkyl groups. Branched alkyl chains having a chain length of from 10 to 18 carbons and preferably from 12 to 15 carbons, such as isotridecyl, have proven to be very suitable.

For example, a mixture of mono- and di-isotridecyl phosphorates can be used, as is supplied, for example, under the name of Hordaphos® MDIT by Clariant GmbH (Am Unispark 1, D-65843 Sulzbach am Taunus).

By its chemical nature, the coating composition can be an additive or a binder. The binder functionalities can be, for example, epoxy, carboxyl, acrylate, methacrylate, and/or ester groups. The coating composition preferably has at least three, for example four, five, six, or more, binder functionalities, which can be the same or different. The binder functionalities can alternatively be selected from the group consisting of polyepoxides, epoxy resin esters, modified polyepoxides, silicone resins, polyesters, polyacrylates, polymethacrylates, polyacrylate/methacrylates, melamine resins, maleates, maleate oils, maleated polybutadiene resins, and mixtures thereof.

The functionalities can alternatively contain fully polymerized units. However, they may consist of monomeric units. Preferably the binding functionalities are already polymerized or oligomerized. Thus polyesters can be used, for example. However, these preferably contain non-esterified carboxyl groups in the case of anodic electrophoretic paints.

The coating composition can preferably have fully polymerized epoxy units, for example.

The surface of the metal pigments is therefore preferably adapted chemically to the binders used in the electrophoretic paint. The metal pigments present in the anodic electrophoretic paint of the invention can thus migrate in the electric field electrophoretically and are deposited anodically like the binding components of the anodic electrophoretic paint.

Coating compositions that are functionalized in this way contribute, surprisingly, to the corrosion-resistance of the metal pigments in the aqueous electrophoretic paint. Thus the gassing (hydrogen evolution) of leafing aluminum pigments can be effectively suppressed.

Preferably, modified ester resins can be used as such coating compositions for the anodic electrophoretic paint. More preferably, modified polyester resins are used. An example is the product Setal L 6306 SS-60 (supplied by Akzo Nobel). It is a carboxyl-functionalized polyester having an acid number of 20 mg KOH/g and a hydroxyl number of 2.7.

Modified epoxy resins and/or acrylate resins are also preferably used as coating compositions for the metal pigments used in the anodic electrophoretic paint of the invention. Epoxy resins modified with phosphoric acid derivatives, phosphoric acid ester derivatives, phosphonic acid derivatives and/or phosphonic acid ester derivatives, or mixtures thereof, are preferred. Such functions apparently have a sufficiently negative charge and additionally enhance the gassing stability, particularly of aluminum pigments. Products of the Resydrol series (supplied by Akzo Nobel, or Cytec, Graz, Austria) have proven to be very suitable coating compositions.

The coating compositions are preferably used in quantities ranging from 1 to 200% by weight, based on the weight of the uncoated metal pigment. If used in a quantity below 1%, their effect is too small and the metal pigments are no longer deposited reliably, particularly after a bath time of 60 days. If used in a quantity exceeding 200% by weight, an unnecessarily large amount of coating composition is used. A correspondingly large amount of metal pigments would then have to be incorporated in the electrophoretic paint, in which case, excess coating composition could adversely affect the properties of the electrophoretic paint. The coating compositions are preferably used in quantities ranging from 10 to 150% by weight, more preferably from 20 to 100% by weight, and very preferably from 30 to 70% by weight, always based on the weight of the uncoated metal pigment. These data in each case refer to the coating composition itself and not to any solvent possibly present in which the coating composition may have been supplied in its commercial stock form.

The coating composition can, but need not, completely envelop the metal pigments.

In another embodiment of the invention, those binders are used as coating compositions for the metal pigments that are used as binders in anodic electrophoretic painting. However, in this case, the binders must have the functional groups mentioned above, in order to permanently adhere or bind to the effect pigment in a suitable manner, since otherwise the coating might delaminate from the metal pigment and ultimately detach itself therefrom in the aqueous electrophoretic paint. Such binding may alternatively take place, if appropriate, by making use of other suitable binders, such as organofunctional silanes or modified binders provided with adhesive groups for the effect pigment.

Binders that are suitable for anodic electrophoretic paints have acid numbers of preferably from15 to 300 mg KOH/g, more preferably from 25 to 160 mg KOH/g of binder and very preferably from 50 to 130 mg KOH/g of binder. These binders preferably have a hydroxyl number of from 0 to 160 mg KOH/g of binder and more preferably from 30 to 100 mg KOH/g of binder.

The following resins are suitable for anodic electrophoretic paints: polyacrylate resins, polymethacrylate resins, polyester resins, polyurethane resins, epoxy resins, epoxy resin esters, modified epoxy resins and silicone resins. Furthermore, combinations of these functionalities, e.g., urethanized polyester resins, acrylated polyester resins or polyurethane resins, polyol-modified polyesters, maleated oils or maleated polybutadiene resins are suitable.

For binding the metal pigment to the coating composition, organofunctional silanes of the formula RzSi(OR′)_{(4-z)} may be used. Here R is an organofunctional group, R′ an alkyl group containing 1 to 6 carbons and z an integer from 1 to 3.

R′ is preferably ethyl or methyl and R preferably contains acrylate groups, methacrylate groups, vinyl groups, isocyanato groups, hydroxyl groups, carboxyl groups, thiol groups, cyano groups, or ureido groups, as the functional groups.

Such silanes are commercially available. For example, they include many representatives of the products manufactured by Degussa, Rheinfelden, Germany and marketed under the trade name “Dynasylan®” or the Silquest® silanes supplied by OSi Specialties, or GENOSIL® supplied by Wacker, Burghausen, Germany.

Examples thereof include 3-methacryloxypropyltrimethoxysilane (Dynasylan MEMO, Silquest A-174NT), vinyltri(m)ethoxysilane (Dynasylan VTMO and VTEO, Silquest A-151 and A-171 respectively), 3-mercaptopropyltri(m)ethoxysilane (Dynasylan MTMO or 3201; Silquest A-189), 3-glycidoxypropyltrimethoxysilane (Dynasylan GLYMO, Silquest A-187), tris(3-trimethoxysilylpropyl)isocyanurate (Silquest Y-11597), gamma-mercaptopropyltrimethoxysilane (Silquest A-189), bis(3-triethoxysilylpropyl)polysulfide (Silquest A-1289), bis(3-triethoxysilyl)disulfide (Silquest A-1589), beta-(3,4-epoxycyclohexyl)ethyltrimethoxysilane (Silquest A-186), gamma-isocyanatopropyltrimethoxysilane (Silquest A-Link 35, Genosil GF40), (methacryloxymethyl)trimethoxysilane (Genosil XL 33), (isocyanatomethyl)trimethoxysilane (Genosil XL 43).

The functional groups of the silane must be caused to react with chemically complementary groups of the coating composition in order to form a covalent bond between the organofunctional silane and the coating composition.

The platelet-like metal pigments coated with the coating composition defined above are present in relatively low concentrations in the electrophoretic paint. The concentration is preferably from 0.5 to 5% by weight, more preferably from 1 to 4% by weight and most preferably from 1.5 to 3% by weight, always based on the total weight of the paint.

In the case of extremely high concentrations, the metal pigments can readily settle at the bottom and at extremely low concentrations, the deposition rate may be too low to allow for adequate application of the metal pigments to the workpiece to achieve good coverage of a full-tone paint within the deposition period normally used in electrophoretic painting.

The electrophoretic paint of the invention can contain all commonly used binders as binding agents. Examples thereof include the binders already mentioned above that can also be used as functionalities of the additives. The binders are preferably present in the electrophoretic paint of the invention in quantities of from 5 to 15% by weight, based on the total weight of the electrophoretic paint. The binders are preferably present in the electrophoretic paint in quantities of from 6 to 12% by weight and more preferably from 7 to 10% by weight.

The binders are polyelectrolytes. Binders for anodic electrophoretic paints contain, for example, carboxyl, hydroxyl, or carboamide functions. These functions which are in neutral form relatively nonpolar are neutralized by bases and are therefore relatively polar due to the ionic structure of the salts. This makes the binders colloidally soluble. For example, alkali metal hydroxides, such as lithium hydroxide or potassium hydroxide, or amines, such as triethanolamine, triethylamine, diethanolamine, and diethylamine, are used as bases for neutralization. The quantity of the added amine depends on the quantity and number of the groups of the binder and the metal pigment used to be ionogenically neutralized.

The water in the electrophoretic paint is usually distilled water or demineralized water since any ions present can impair the solubility of the binders even in small concentrations.

Furthermore, the electrophoretic paints of the invention can also contain small quantities of organic solvents as solubilizers. The addition of organic solvents also helps achieve paint films of better quality after deposition. Suitable examples thereof include glycol ethers, such as butyl glycol or ethyl glycol, alcohols, such as butanol, and higher alcohols, such as decanol or tridecyl alcohol.

These organic solvents are preferably present in the electrophoretic paint in quantities of from 1 to 6% by weight and preferably from 1.5 to 5% by weight, always based on the total weight of the paint. Larger quantities of organic solvents can lead to a reduction in the film resistance and thus to less homogenous layer thicknesses of the coating on the workpiece.

Furthermore, the electrophoretic paints of the invention may contain conventional inorganic and/or organic colored pigments, fillers, corrosion inhibitors, and additives, such as dispersing agents, anti-settling agents, or anti-foaming agents. These should not react with water in the weakly basic to neutral region and, in particular, should not introduce any unwanted foreign ions.

Examples of suitable fillers are talcum, silicon dioxide, aluminum hydroxide, aluminum silicates, mica, silicic acids, calcium carbonate, and barium sulfate. The fillers can be present in an uncoated form or they may be coated with organic compounds.

Furthermore, the electrophoretic paints of the invention can contain conventional organic and/or inorganic pigments. The pigments used here are not chemically basic. Otherwise, unwanted metal salts would be immediately formed due to salt formation with the respective binders.

Examples of chromophoric inorganic pigments are: lead carbonate, lead sulfate, iron oxides, tin oxide, antimony oxide, chrome orange, chrome yellow, nickel-titanium yellow, molybdate red, mineral violet, ultramarine violet, ultramarine blue, cobalt blue, chrome oxide green, titanium dioxide, micronized titanium dioxide, zinc sulfide, lithopone, and lamp black.

Examples of chromophoric organic pigments are: azo pigments, phthalocyanine pigments, chinacridone pigments, anthraquinone pigments, thioindigo pigments, perylene pigments, perinone pigments, and diketopyrrolopyrrole pigments. The aforementioned pigments can be added, individually or in any combination, to the anodic electrophoretic paint of the invention.

Furthermore, the electrophoretic paints of the invention may contain conventional reactive diluents and co-curing agents.

Furthermore, the electrophoretic paints of the invention may contain conventional paint additives such as biocides, screening agents, or flow-control agents.

The anodic electrophoretic paints of the invention preferably have a solids content of from 7 to 40% by weight, preferably from 8 to 18% by weight and more preferably from 9 to 16% by weight, always based on the total weight of the electrophoretic paint.

The method for the production of an electrophoretic paint of the invention comprises the following steps:

(a) coating the metal pigment with the coating composition,

(b) mixing the coated metal pigment obtained in step (a) with at least one organic solvent or solvent mixture and optionally with at least one binder of the electrophoretic paint to give a metal pigment pulp,

(c) mixing the metal pigment pulp obtained in step b) with an aqueous dispersion of further binder or at least one other binder of the electrophoretic paint,

(d) adding additional water at least till a thin consistency is obtained,

(e) adding base in step c) or step d) to achieve the desired pH.

Coating the Metal Pigment with a Coating Composition

Coating the metal pigment with a coating composition can take place in many ways. The metal pigment can be placed in a mixer or kneader in the form of a paste. Then the coating composition is added and is allowed to act on the metal pigment for at least 5 min. The coating composition is preferably added in the form of a solution or dispersion. It can be an aqueous solution or a predominantly organic solution.

Furthermore, the metal pigment may initially be dispersed in a solvent. The coating composition is then added with stirring. The solvent in which the coating composition is dissolved should preferably be miscible with the solvent in which the metal pigment is dispersed. If necessary, elevated temperatures may be used (up to the boiling point of the solvent (mixture)). However, room temperature is usually sufficient to cause the coating composition to effectively coat the metal pigment.

Thereafter, the pigment is freed from solvent and either dried to form a powder and/or worked to a paste in another solvent, if required. Water, alcohols, such as, ethanol, isopropanol, n-butanol, or glycols, for example, butyl glycol, are suitable solvents. The solvent should be miscible with water. The pigment of the invention is marketed in the form of a paste or powder. The pastes have a nonvolatile content of from 30 to 70% by weight, based on the total paste. The paste preferably has a nonvolatile content of from 40 to 60% by weight and more preferably from 45 to 55% by weight, always based on the total weight of the paste.

In a preferred embodiment of the invention, the coating composition in step a) corresponds to at least one binder of the electrophoretic paint.

For this embodiment, in which the coating composition is identical to a binder used in the electrophoretic paint, the following variant presents a special method comprising the following steps:
a) preparing a solution or dispersion of a binder, which is suitable for electrophoretic paints, in an organic solvent,
b) coating the metal pigment with the binder by
   i) dispersing the metal pigment in the solution or dispersion of a) and then spraying or
   ii) spraying the solution or dispersion of a) on metal pigments turbulized in a gas stream,
c) drying the metal pigments coated with the binder in a moving gas stream,
d) optionally working the pigment to a paste in water and/or an organic solvent,
e) optionally neutralizing the mixture with a base.

The spraying and drying can preferably take place in a spray drier. Preferably, highly volatile solvents, such as acetone and/or ethyl acetate, are used.

Mixing the Metal Pigment with a Solvent and Optionally with at Least One Binder of the Electrophoretic Paint (“Pulping”)

The metal pigments are pulped in this step. They are dispersed in a solvent and preferably mixed with a portion of the binder of the electrophoretic paint. The ratio of added binder to the metal pigment is preferably from 5:1 to 1:5 and more preferably from 2:1 to 1:2. Due to this step, the metal pigments are well dispersed and pre-wetted by the binder.

If appropriate, other auxiliary materials, e.g., wetting agents or waxes may be added.

c) Mixing the Metal Pigment Decomposition with Binder and Water (“Paint Formation”)

An aqueous binder dispersion is placed in the mixer. This binder can be similar to or different from the one used under b). Then the metal pigment from step b) is added to form an aqueous binder dispersion, preferably with stirring.

d) Addition of Water and Neutralization (“Adjustment”)

Demineralized water is added to the metal pigment/binder dispersion produced in step c), preferably with stirring. The quantity of water added is preferably from 25% by weight to 50% by weight of the total weight of the metal pigment/binder dispersion.

The pH is then adjusted preferably to from 7.3 to 8.7, more preferably to from 7.5 to 8.5 and most preferably from to 7.8 to 8.3, by adding a base. This causes the binder and also the metal pigment coated with the coating composition to be substantially neutralized and thus converted to a salt form. Subsequently additional water is added with stirring until the originally relatively thick paint assumes a thin consistency. This is also referred to as breaking the so-called “water mountain”. Then additional water is added and the solids content of the electrophoretic paint is adjusted to from 7 to 40% by weight, based on the total weight of the paint. If desired, additional water may be added to give the desired solids content.

The addition of base, or neutralization, can alternatively take place after mixing the metal pigment pulp with the aqueous binder dispersion (paint formation).

Conventional bases are suitable for neutralization. Examples thereof are: NaOH, KOH, ammonia, LiOH, amines, such as diethylamine, triethylamine, morpholine, and ethylene diamine, or alkanolamines, such as dimethylaminoethanol, dimethylamino-2-methylpropanol, or trimethylethanolamine, or mixtures of different bases. The quantity of base used should be such that at least 25 mol % and preferably 40 mol % of the acid groups of the metal pigment coated with the coating composition is present in neutral form. Any functionalities derived from the metal pigment itself may also be counted as acid groups. These can be, for example, acrylic acid functions, in the case of a metal pigment coated with synthetic resins, or stearic acid, in the case of leafing metal pigments, as starting pigments.

The pH of the electrophoretic paint bath at 25° C. is preferably from 7.8 to 8.3. However, due to the proceedure used for preparing the electrophoretic paint, the pH may be subject to fluctuations and must possibly be readjusted prior to the electrochemical deposition process.

The electrophoretic paint of the invention is used for coating a conductive substrate in order to obtain a decorative metallic effect.

The conductive substrate may include the following articles: radiators, fuel tank installations, automobile bodies, automobile accessories, domestic and electrical appliances, steel furniture, components, and building and agricultural equipment.

The following examples illustrate the invention in more detail but without restricting the scope thereof.

### EXAMPLE 1 OF THE INVENTION

Coating the Metal Pigment:

80 g of a paste of 9 g of PCA 214 (aluminum pigment coated with organic polymers and having a d₅₀ of 32 μm; supplied by Eckart GmbH & Co. KG) are mixed with 80 g of butyl glycol to form a homogeneous pigment paste. Then 40 g of SETAL 6306 SS-60 (polyol-modified polyester supplied by Akzo Nobel, P.O. Box 79, 4600 AB Bergen op Zoom, Netherlands) is added with stirring. This pigment paste is allowed to stand overnight.

Production of the Electrophoretic Paint:

26 g of the metal pigment paste is mixed with 26 g of an acrylate resin (supplied by Emil Frei GmbH & Co. Lackfabrik—Am Bahnhof 6 - D-78199 Braunlingen) in 26 g of butyl glycol. This pigment paste is allowed to stand overnight.

The pigment paste is mixed with 230 g of a ready-mixed, commercially available anodic electrophoretic paint based on acrylate and melamine with gentle stirring using a dissolver disk at 800 rpm, and another 36 g of demineralized water are added.

While stirring, 3.5 g of dimethanolamine in 170 g of demineralized water are added to this dispersion. After stirring for another 10 minutes, just enough distilled water is added with constant stirring to break the so-called “water mountain,” and the enamel displays a thin consistence (about 620 g of demineralized water).

The electrophoretic paint produced according to this formulation for anodic electrophoretic painting is characterized by a viscosity of 9±1 seconds at a temperature of 20° C., measured in a DIN 4 flow cup. The solvent portion of the bath is 3.0% by weight. The electrophoretic paint has a solids content of 12±0.1%. The pH of the electrophoretic paint bath is found to be 8.2 at 25° C. The content of aluminum pigment in the electrophoretic paint is approx. 1% by weight.

### EXAMPLE 2 OF THE INVENTION

The production of the electrophoretic paint takes place as in Example 1, except that an aluminum effect pigment having an average particle size d₅₀ of 18 μm, PCA 9155 (supplied by Eckart GmbH & Co. KG) is used.

### EXAMPLE 3 OF THE INVENTION

The production of the electrophoretic paint takes place as in Example 1, except that a leafing aluminum effect pigment having an average particle size d₅₀ of 18 μm, VP 53 976 (supplied by Eckart GmbH & Co. KG).

### EXAMPLE 4 OF THE INVENTION

80 g of a paste of 9 g of PCA 214 (aluminum pigment coated with organic polymers and having a d₅₀ of 32 μm; supplied by Eckart GmbH & Co. KG, Fuerth, Germany) are mixed with 80 g of butyl glycol to form a homogeneous pigment paste. 40 g of Resydrol AH 509w/45WA (phosphoric acid-modified acrylate resin; supplied by Cytec, Graz, Austria) are then added with stirring. This pigment paste is allowed to stand overnight.

The production of the electrophoretic paint takes place as in Example 1.

### EXAMPLE 5 OF THE INVENTION

The production of the electrophoretic paint takes place as in Example 4, except that an aluminum effect pigment having an average particle size d₅₀ of 18 μm, PCA 9155 (supplied by Eckart GmbH & Co. KG) is used.

The electrophoretic paint is prepared as in Example 1.

### EXAMPLE 6 OF THE INVENTION

The production of the electrophoretic paint takes place as in Example 4, except that a leafing aluminum effect pigment having an average particle size d₅₀ of 18 μm, VP 53,976 (supplied by Eckart GmbH & Co. KG) is used.

The production of the electrophoretic paint takes place as in Example 1.

### COMPARATIVE EXAMPLE 7

The production of the electrophoretic paint takes place as in Example 1, except that a very coarse aluminum pigment, PCA 211 (supplied Eckart GmbH & Co. KG) having an average particle size d₅₀ of 73 μm is used.

### COMPARATIVE EXAMPLE 8

### Anodic Electrophoretic Paint

The production of the anodic electrophoretic paint takes place as in Example 1 except that 26 g of an aluminum effect pigment having an average particle size D₅₀ of 18 μm, PCA 9155 (supplied by Eckart GmbH & Co. KG) in paste form (solids content:50% by weight), without previous coating with the polyol-modified polyester, are used.

Unlike Examples 1 to 3 of the invention, 40 g of the polyol-modified polyester (SETAL 6306 SS-60, supplied by Akzo Nobel) are introduced into the electrophoretic bath only after the metal pigment paste has been incorporated in the commercially available anodic electrophoretic paint (supplied by Frei Lacke).

Thus the addition does not take place as in Examples 1 to 3 of the invention by directly working the coating composition with the aluminum effect pigment to form a paste prior to paint formation.

### COMPARATAIVE EXAMPLE 9

PCA 9155 (supplied by Eckart GmbH & Co. KG), an aluminum effect pigment having an average particle size d₅₀ of 18 μm in paste form (solids content:50% by weight) and coated with synthetic resin, is incorporated in the anodic electrophoretic paint without further coating. Unlike Examples 4 to 6 of the invention, the phosphoric acid-modified acrylate resin is introduced into the electrophoretic bath only after the addition of the commercially available anodic electrophoretic paint (supplied by Frei Lacke). Thus the addition does not take place as in Examples 4 to 6 of the invention by directly working the additive (coating composition) with the aluminum effect pigment to a paste prior to electrophoretic painting.

### COMPARATIVE EXAMPLE 10

### Anodic Electrophoretic Paint

The paint formation takes place as in Example 1 using 26 g of an aluminum effect pigment having an average particle size d₅₀ of 18 μm, PCA 9155 (supplied Eckart GmbH & Co. KG) in paste form (solids content:50% by weight) without further coating. Also, no additional coating composition is added to the electrophoretic paint.

The electrochemical deposition process for anodic electrophoretic painting takes place in a conductive vessel, a so-called tank, which is made of an electrically conductive material and is wired as the cathode in the electric circuit. The workpiece to be coated, which is a metal sheet measuring 7.5 cm×15.5 cm in the exemplary embodiment of the invention, is connected as the anode and suspended in the electrophoretic bath to two thirds of its length.

In order to prevent sedimentation and the formation of dead spots, the bath is moved at an average flow speed of approx. 0.1 m/s. Subsequently, a voltage of 100 V is applied over a duration of 120 seconds. The workpiece thus coated is then thoroughly rinsed with distilled water in order to eliminate residues of uncoagulated resin. The workpiece is then allowed to dry in air for 10 minutes. Cross-linking and baking of the electrophoretic paint then take place over a period of 20 minutes at 180° C. The paint layer thus obtained has a thickness of 30±2 μm.

The electrophoretic paints produced according to Examples 1 to 3 of the invention have an extremely long shelf life and an extremely high deposition stability as regards the aluminum effect pigments present therein. This is clearly shown in Table 1. The paints were stored at room temperature and used for electrophoretic painting at intervals of 7 days. These tests were discontinued after 92 days.

All of the Examples 1 to 5 of the invention and the comparative examples were also subjected to gassing tests. For this purpose, 25 g of the electrophoretic paints were heated at 40° C. in a gas bottle having a double chamber pipe attachment, and the quantity of evolved gas (H₂, which results from the reaction of the aluminum pigments with water) was measured. The test is considered to be passed if no more than 20 mL of hydrogen have evolved after 30 days. The test results are summarized in Table 1.

TABLE 1
Behavior of the anodic electrophoretic paint

| | | | Gassing |
|---|---|---|---|
| | Deposition stability | | after 30 days |
| Sample | (in d) | | (mL H₂) |
| Example 1 | >92 | d | 5 |
| Example 2 | >92 | d | 5 |
| Example 3 | >92 | d | 5 |
| Example 4 | >92 | d | 4 |
| Example 5 | >92 | d | 5 |
| Example 6 | >92 | d | 4 |
| Comparative Example 7 | Approx. 28 | d | 4 |
| Comparative Example 8 | <7 | d | 5 |
| Comparative Example 9 | <7 | d | 6 |
| Comparative Example 10 | <7 | d | >30 mL |
| | | | after 13 d |

For Examples 1 to 6 of the invention, reproducible results with respect to the optical appearance of the coated test sheet metals were obtained even after more than 92 days of storage at room temperature. Furthermore, they did not display any significant gassing in the aqueous electrophoretic paints.

Comparative Examples 8 and 9 were likewise gassing stable. However, they had virtually no deposition stability or bath stability. The coarse aluminum pigment used in Comparative Example 7 was gassing stable and could initially be deposited reproducibly. However, after four weeks, the coverage achieved by the coating of electrophoretic paint decreased markediy. Thus no satisfactory bath stability could be obtained in this case either. Those aluminum pigments of Comparative Example 10 that were not provided with the coating of the invention, are neither gassing stable nor do they have sufficient deposition stability.

### COMPARATIVE EXAMPLE 11

### Powder Paint Containing Metal Pigment

9 g of a commercially available effect pigment for the powder paint, Spezial PCA 214 (supplied by EckartWerke GmbH) are intimately combined with 291 g of a powder varnish, (AL 96 Polyester PT 910 System (supplied by Du Pont) and 0.6 g of a so-called “free flow additive”, Acematt OK 412 (supplied by Degussa) in a plastic bag. The contents are then decanted directly into a mixing vessel resembling a commercial kitchen mixer in terms of construction and form (Thermomix supplied by Vorwerk), and then blended for 4 minutes at 25° C. at a medium stirring speed. This procedure corresponds to the “dry blend method” used in powder painting. The system thus produced is applied by means of a conventional corona charging technique (GEMA electrostatic spray gun PG 1-B) to a conventional test metal sheet (“Q-Panel”). The application conditions for the powder painting technique used here are the following: Powder hose connection: 2 bar; flushing air connection: 1.3 bar, voltage: 60 kV; material flow regulator: approx. 50%, distance of spray gun from the sheet metal: approx. 30 cm.

The powder painting system is then baked and cross-linked in an oven. The baking time is 10 minutes at a temperature of 200° C. The dry layer thickness achieved by this method is from 50 to 75 μm.

### COMPARATIVE EXAMPLE 12

### Powder Paint Containing Metal Pigment

Similar to Comparative Example 6, but using Spezial PCA 9155 (supplied by Eckart Werke GmbH) as the metal effect pigment.

The different coatings obtained in Examples 1 to 6 of the invention and Comparative Examples 7 to 10 were compared with the substrates of Comparative Examples 11 and 12 coated by powder coating technology. Aluminum effect pigments of similar particle size and coloristic properties were used to effect comparative evaluation, as can be seen from Examples 1 to 6.

The coatings achieved in Examples 1 to 6 of the invention surprisingly show excellent covering power equal, in terms of quality, to that of the powder paint coatings of Comparative Examples 10 and 11.

The optical characteristics are compared by way of observers' visual impressions. Surprisingly, it is found that Examples 1, 2, 4, and 6 show no appreciable differences in terms of brightness and metallic effect from conventional powder paint coatings produced in Comparative Examples 11 and 12.

Reference is made to DIN 53 230 when evaluating the optical properties. The properties and/or variations therein must often be evaluated subjectively when examining coating materials, paints, and similar coatings. DIN 53 230 specifies an evaluation system for such cases. It describes the manner in which test results should be evaluated when they cannot be referenced to directly determined measured values.

Reference is made to the “Fixed rating scale” explained in Section 2.1 of DIN 53 230 for evaluation of the Examples and Comparative Examples 1 to 12. The fixed rating scale is a scale for evaluating the intensity of the properties. The best possible value is referred to therein by the score 0, and the worst possible value by the score 5, where the term “worst possible value” means that any change or deterioration beyond this value is no longer of interest from the application engineering point of view.

The coloristic and optical properties determined with reference to DIN 53230, Section. 2.1, are listed in Table 2. The scores were determined by means of the subjective impressions of a number of persons. In all cases, agreement in the subjective impressions of the persons providing the evaluation could be established.

TABLE 2
Optical comparison of the electrophoretic paint coatings obtained
in Examples and Comparative Examples 1-12.

| | Average | | | |
|---|---|---|---|---|
| | particle | | | |
| | size | Covering | | |
| | d₅₀ | power | brightness | General visual |
| Sample | [μm] | [score] | [score] | impression |
| Example 1 of the | 32 | 1 | 1 | Very good metallic |
| invention | | | | sparkling effect |
| Example 2 of the | 16 | 0 | 1 | Very metallic, |
| invention | | | | weaker sparkling |
| | | | | effect |
| Example 3 of the | 18 | 1 | 1 | Very good metallic |
| invention | | | | leafing effect, high |
| | | | | luster, abrasion- |
| | | | | resistant |
| Example 4 of the | 32 | 1 | 0 | Very good metallic |
| invention | | | | sparkling effect |
| Example 5 of the | 16 | 0 | 1 | Very metallic, lower |
| invention | | | | sparkling effect |
| Example 6 of the | 18 | 1 | 1 | Very good metallic |
| invention | | | | leafing effect, high |
| | | | | luster, abrasion- |
| | | | | resistant |
| Comparative | 73 | 3 | 1 | Strong metallic |
| Example 7 | | | | sparkling effect |
| Comparative | 16 | 3 | 3 | Weaker metallic |
| Example 8 | | | | effect due to poor |
| | | | | covering power |
| Comparative | 16 | 3 | 3 | Weaker metallic |
| Example 9 | | | | effect due to poor |
| | | | | covering power |
| Comparative | 18 | 5 | 5 | Virtually no metal |
| Example 10 | | | | pigment deposited |
| Comparative | 32 | 0 | 1 | Very good metallic |
| Example 11 | | | | sparkling effect |
| Comparative | 16 | 0 | 0 | Very metallic, lower |
| Example 12 | | | | sparkling effect |

The above comparison shows that the pigments and pigment compositions developed according to the invention in Examples 1, 2, 4, and 6 are comparable in terms of their optical characteristics to powder coating pigments and applications that have been well-established on the market for many years. It clearly follows from the comparison of the scores of Examples 1 and 2, and also 4 and 6, with Comparative Examples 11 and 12 that their optical characteristics are almost identical in terms of coverage, luster and metallic effect.

Examples 3 and 6 of the invention also show, surprisingly, an optical impression in an electrophoretic paint which is reminiscent of a conventional leafing paint. However, unlike conventional leafing paints, the coating was, surprisingly, abrasion-resistant.

Comparative Example 7 likewise shows good optical characteristics. Due to the very coarse aluminum pigment, the coverage is low. However, a strong metallic sparkling effect is observable, but, this pigment did not have sufficient bath stability.

Comparative Examples 8 and 9, in which the coating composition was introduced directly into the electrophoretic bath in the final stage of the electrophoretic bath production, display deviations. Clear losses in terms of coverage, luster, and the associated metallic effect are seen in this variant.

A metal pigment not treated in any way with a coating composition (Comparative Example 10) is virtually impossible to deposit in an anodic electrophoretic paint, although the metal pigment has a synthetic resin coating.

The conclusion to be drawn from the above is that it is clearly necessary to apply the coating composition (additive) directly to the pigment itself, as proposed by the invention, and not add it later to the paint bath. It is presumed that the additive with its pigmentophilic groups can form a physisorptive and/or chemisorptive bond to the pigment surface, which then appears to play a decisive key role in influencing the deposition properties of the pigment.

1) An anodic electrophoretic paint comprising at least one binding agent for anodic electrophoretic paint and an aqueous liquid medium, wherein
said anodic electrophoretic paint additionally contains at least one platelet-type metal pigment coated with a coating composition, wherein
(a) the platelet-type metal pigment has a d₅₀ value of the cumulative size distribution curve of from 4 to 35 μm and is selected from the group consisting of leafing metal pigments, metal pigments coated with synthetic resin(s), and mixtures thereof, and
(b) the coating composition is a coating composition having an organic backbone containing at least 10 carbons and possessing one or more functional groups for effecting adhesion or binding to the pigment surface, wherein the functional group is selected from the group consisting of phosphonic acids, phosphonates, phosphoric acids, phosphate esters, sulfonates, polyalcohols, and mixtures thereof, and
(c) the coating composition exhibits acidic properties.

2) The anodic electrophoretic paint according to claim 1, wherein
said electrophoretic paint contains said metal pigment in a concentration of from 0.5 to 5 wt %, based on the total weight of the paint.

3) The anodic electrophoretic paint according to claim 1, wherein
said electrophoretic paint contains said binding agent in a concentration of from 5 to 15 wt %, based on the total weight of the paint.

4) The anodic electrophoretic paint according to claim 1, wherein
said binding agent is selected from the group consisting of epoxy resins, acrylates, methacrylates, polyesters, melamine-formaldehyde resins, maleates, and copolymers and mixtures thereof.

5) The anodic-electrophoretic paint according to claim 1, wherein
said platelet-type metal pigments are of metals or alloys selected from the group consisting of aluminum, copper, zinc, brass, iron, titanium, chromium, nickel, steel, silver, and alloys thereof.

6) The anodic electrophoretic paint according to claim 1, wherein
the synthetic resin coating on the metal pigment comprises at least one acrylate and/or methacrylate.

7) The anodic electrophoretic paint according to claim 1, wherein
the leafing metal pigment is a metal pigment which has been ground and/or after-polished in the presence of a fatty acid or fatty acids, which can contain linear or branched alkyl chains each preferably having from 10 to 30 carbons, wherein stearic acid and/or palmitic acid preference are preferred as fatty acid(s).

8) The anodic electrophoretic paint according to claim 1, wherein
the organic backbone of the coating composition metal pigment contains from 10 to 800 carbons and preferably from 12 to 100 carbons and is selected from the group consisting of alkyl, alkenyl, alkynyl, aryl, alkylaryl, arylalkyl, alkenylaryl, arylalkynyl, alkynylaryl, cycloalkyl, alkylcycloalkyl, cycloalkylalkyl, perfluorinated alkyl, partially fluorinated alkyl, perfluorinated aryl, partially fluorinated aryl, perfluorinated alkylaryl, and partially fluorinated alkylaryl, and combinations and mixtures thereof.

9) The anodic electrophoretic paint according to claim 1, wherein
the coating composition is capable of being anodically deposited.

10) The anodic electrophoretic paint according to claim 1, wherein
the coating composition is a binding agent for anodic electrophoretic paint.

11) The anodic electrophoretic paint according to claim 1, wherein
the coating composition has one or more binder functionalities of anodic electrophoretic paint binders, wherein the binder functionality is selected from the group consisting of polyepoxides, polyacrylates, polymethacrylates, melamine-formaldehyde resins, maleates, copolymers, and mixtures thereof.

12) The anodic electrophoretic paint according to claim 1, wherein
the coating composition has an acid value of from 15 to 300 mg KOH/g of coating composition.

13) The anodic electrophoretic paint according to claim 1, wherein
the coating composition is a phosphoric acid ester of formula (I) or a phosphonic acid ester of formula (II): 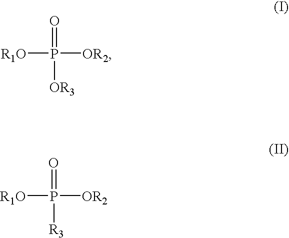
wherein R₁, R₂, and R₃ independently stand for
alkyl having from 10 to 20 carbons, which may be straight-chain or branched-chain and optionally substituted by fluorine and/or hydroxyl,
aryl having from 6 to 24 carbons, which may be substituted by alkyl containing from 1 to 6 carbons, fluorine, and/or hydroxyl,
wherein the total number at carbons is at least 10,
wherein R₁ and R₂ can independently also denote hydrogen.

14) The anodic electrophoretic paint according to claim 13, wherein
the platelet-type metal pigment is a leafing metal pigment.

15) The anodic electrophoretic paint according to claim 1, wherein
the coating composition is a dialkyl phophorate or dialkyl phosphonate, wherein the two alkyl chains each independently have a chain length of from 10 to 18 carbons.

16) A method for the production of an electrophoretic paint according to claim 1, wherein
it comprises the following steps:
a) coating said metal pigment with said coating composition
b) mixing said metal pigment coated in step a) with at least one organic solvent or solvent mixture and optionally with at least one binding agent of the electrophoretic paint to give a metal pigment pulp,
c) mixing the metal pigment pulp obtained in step b) with an aqueous dispersion of further binding agent and/or at least one other binding agent of the electrophoretic paint,
d) adding a further quantity of water at least until a thin consistency is achieved.
e) adding base in step c) or step d) to give the desired pH.

17) use of an anodic electrophoretic paint according to claim 1 for coating an electrically conductive substrate or object.

18) An object coated with an anodic electrophoretic paint according to claim 1, preferably selected from the group consisting of radiators, fuel tank installations, automobile bodies, automobile accessories, domestic and electrical appliances, furniture, steel furniture, components, and building and agricultural equipment.

19) The use of platelet-type leafing metal pigments, which are coated with a phosphate ester of formula (I) or a phosphonate of formula (II): 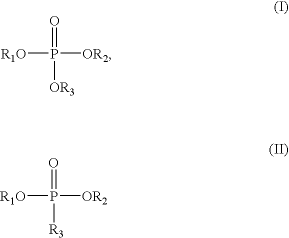
wherein R₁, R₂, and R₃ independently stand for
alkyl having from 10 to 20 carbons, which may be straight-chain or branched-chain and optionally substituted by fluorine and/or hydroxyl,
aryl having from 6 to 24 carbons, which may be substituted by alkyl containing from 1 to 6 carbons, fluorine, and/or hydroxyl,
wherein the total number of carbons is at least 10,
wherein R₁ and R₂ can independently also stand for hydrogen, and
wherein the pigments have a d₅₀ value of the cumulative size distribution curve of from 4 to 35 μm, for the production of an anodic electrophoretic paint or for anodic electrophoretic painting.

20) The use according to claim 19, wherein
said coating composition is a dialkyl phophorate or dialkyl phosphonate, wherein the two alkyl chains each independently have a chain length of from 10 to 18 carbons.

21) The use according to claim 19, wherein
said platelet-type metal pigments are of metals or alloys selected from the group consisting of aluminum, copper, zinc, brass, iron, titanium, chromium, nickel, steel, silver, and alloys thereof.

22) The use of platelet-type leafing metal pigments and/or metal pigments coated with synthetic resin(s), wherein the pigments are coated with a coating composition comprising an organic backbone having from 10 to 800 carbons, preferably from 12 to 100 carbons, and selected from the group consisting of alkyl, alkenyl, alkynyl, aryl, alkylaryl, arylalkyl, alkenylaryl; arylalkynyl, alkynylaryl, cycloalkyl, alkylcycloalkyl, cycloalkylalkyl, perfluorinated alkyl, partially fluorinated alkyl, perfluorinated aryl, partially fluorinated aryl, perfluorinated alkylaryl, and partially fluorinated alkylaryl, and combinations and mixtures thereof, and wherein the pigments have a d₅₀ value of the cumulative size distribution curve of from 4 to 35 μm, for the production of an anodic electrophoretic paint or for anodic electrophoretic painting.
